(19) United States
(12) Patent Application Publication
(10) Pub. No.: US 2004/0003929 A1
(43) Pub. Date: Jan. 8, 2004

(54) Firefighting system

(76) Inventor: Darrell Graf, Fargo, ND (US)

Correspondence Address: Michael S. Neustel, 2534 South University Drive, Suite No. 4, Fargo, ND, 58103, US

(21) Appl. No.: 10/189,893

(22) Filed: Jul. 2, 2002

(51) Int. Cl. A62C 3/07

(52) U.S. Cl. 169/62

(57) ABSTRACT

A firefighting system for attachment to a standard commercially available pickup truck allowing safe and efficient single operator firefighting. The firefighting system includes a stand-alone, easily transportable water and foam dispensing system and control panel with stand. The water and foam dispensing system is attached to the bed of a standard commercially available pickup truck. The water and foam dispensing system includes containers to hold the firefighting systems water and foam. The control panel with stand is attached to the floor of the cab of the standard commercially available pickup. This arrangement allows for a single operator to drive the vehicle and directs the water and foam stream from inside the cab of the pickup.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to firefighting systems and more specifically it relates to a stand-alone firefighting system for attachment to a standard commercially available pickup truck allowing safe and efficient single operator firefighting.

2. Description of the Related Art

Firefighting systems have been in use for years. Typically, a specially designed fire truck is driven to the scene of a fire. Multiple firemen are then involved in attaching fire hoses to water sources and pumping water onto the flames of a fire. These specifically designed fire trucks are normally costly and firefighting is typically manpower intensive.

Wildland fires are particularly problematic for current firefighting systems because they tend to occur in more sparsely populated areas where firefighting resources, both vehicles and manpower, are typically extremely limited. Current systems require at least one individual to drive the vehicle and another individual to fight the fire. Clearly, the individual who is outside the vehicle fighting the fire is exposed to the dangers inherent with the heat and smoke associated with fighting a fire. The firefighter is also prone to physical injuries that can result from dragging a fire hose over rough terrain while fighting a wildland fire. For a wildland fire, where the fire may have spread over a large area, one firefighter would be unable to effectively fight the fire as the firefighter would have to constantly stop fighting the fire to move the fire truck to locations closer to where the fire is still burning. Current systems can easily overwhelm the limited manpower associated with many rural fire departments.

Specially designed firefighting equipment is typically expensive and fire departments in rural settings where most wildland fires occur do not have the budget to purchase the current fire fighting vehicles and systems. The use of foam has also been found to be effective in fighting fires, but once again requires a specially designed fire truck to provide that type of firefighting support. These specifically designed firefighting vehicles are not easily maintainable or repairable as their mechanical components are internal to the systems.

While current firefighting equipment may be suitable for the particular purpose to which they address, they are not as suitable for fighting wildland fires by rural fire departments with limited manpower and financial resources. Correspondingly, what the typical rural fire department needs is a cost effective system that performs the duties necessary to handle wildland fires.

In these respects, the firefighting system according to the present invention substantially departs from the conventional concepts and designs of the prior art, and in so doing provides an apparatus primarily developed for the purpose of attachment to a standard commercially available pickup truck allowing safe and efficient single operator firefighting.

### BRIEF SUMMARY OF THE INVENTION

In view of the foregoing disadvantages inherent in the known types of firefighting systems now present in the prior art, the present invention provides a new firefighting system wherein the same can be utilized for attachment to a standard commercially available pickup truck allowing safe and efficient single operator firefighting.

The general purpose of the present invention, which will be described subsequently in greater detail, is to provide a new firefighting system that has many of the advantages of the firefighting systems mentioned heretofore and many novel features that result in a new firefighting system which is not anticipated, rendered obvious, suggested, or even implied by any of the prior art firefighting systems, either alone or in any combination thereof.

To attain this, the present invention generally comprises a stand-alone, easily transportable water and foam dispensing system and control panel with stand. The water and foam dispensing system is attached to the bed of a standard commercially available pickup truck. The water and foam dispensing system includes containers to hold the firefighting systems water and foam. The control panel is mounted on a stand which is attached to the floor of the cab of the standard commercially available pickup. This arrangement allows for a single operator to drive the vehicle and direct the water or foam stream from inside the cab of the pickup. Placing the mechanical components of the firefighting system in the bed, and therefore external to the pickup truck, allows easy access for repair and maintenance.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a firefighting system that will overcome the shortcomings of the prior art devices.

A second object is to provide a firefighting system for attachment to a standard commercially available pickup truck allowing safe and efficient single operator firefighting.

Another object is to provide a firefighting system that uses readily available, standard commercial, vehicles as the platform for the system.

An additional object is to provide a firefighting system that is economical to purchase, install and operate.

A further object is to provide a firefighting system that allows the systems operation by a single individual.

Another object is to provide a firefighting system that allows a fire to be fought from the less stressful environment of the vehicle's air-conditioned cab.

An additional object is to provide a firefighting system that protects the operator from heat and smoke.

A further object is to provide a firefighting system that relieves the operator from physical injuries associated with dragging a fire hose-over rough terrain.

An additional object is to provide a firefighting system that keeps the pump from overheating by recirculating water to the pump.

A further object is to provide a firefighting system that is easily maintainable and repairable.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective of the present invention.

FIG. 2 is a flowchart of the control panel interface.

FIG. 3 is a flowchart of the fluid distribution system of the present invention.

FIG. 4 is a top view of the control panel.

FIG. 5 is a side perspective of the control panel and mounting stand.

### DETAILED DESCRIPTION OF THE INVENTION

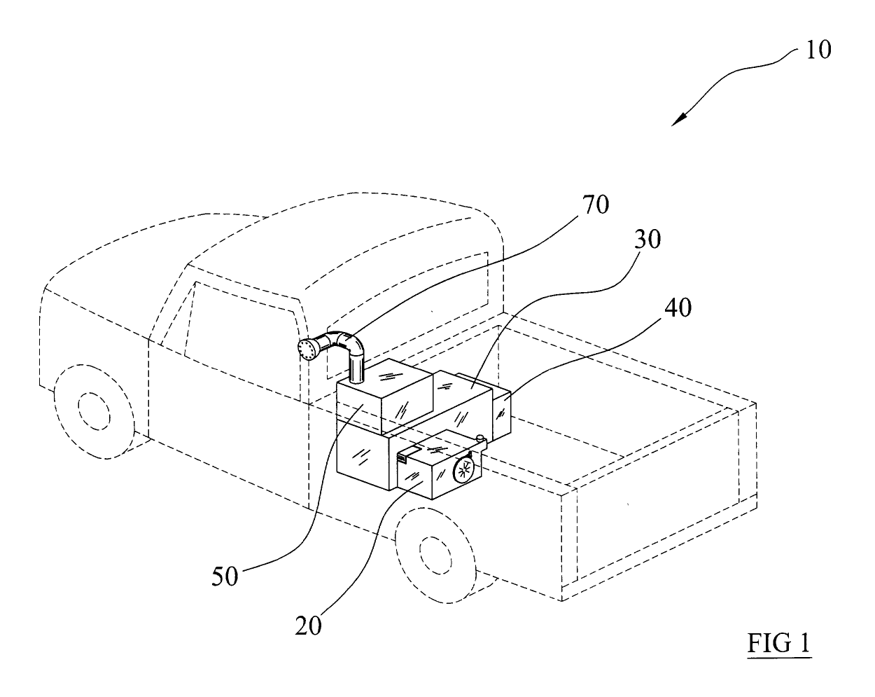

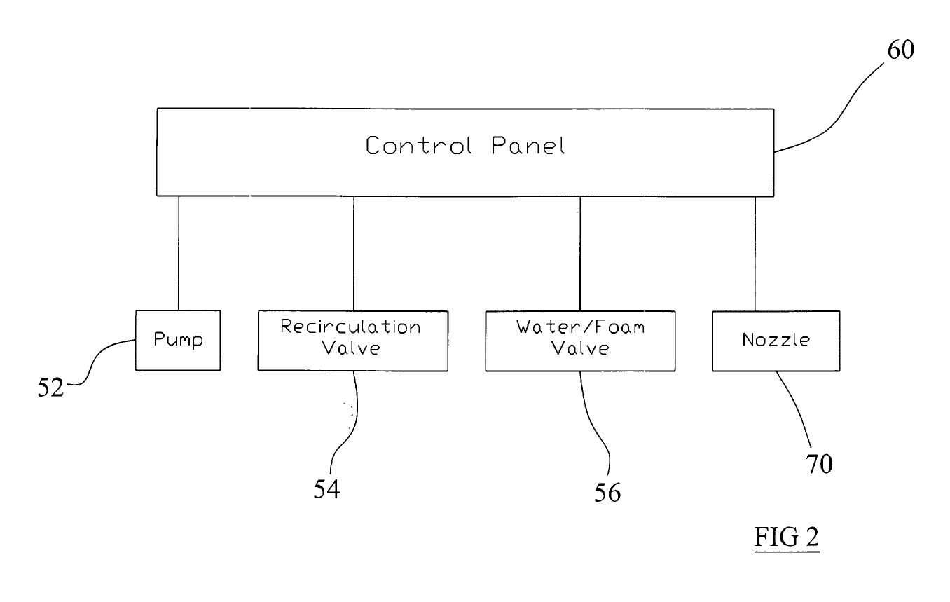

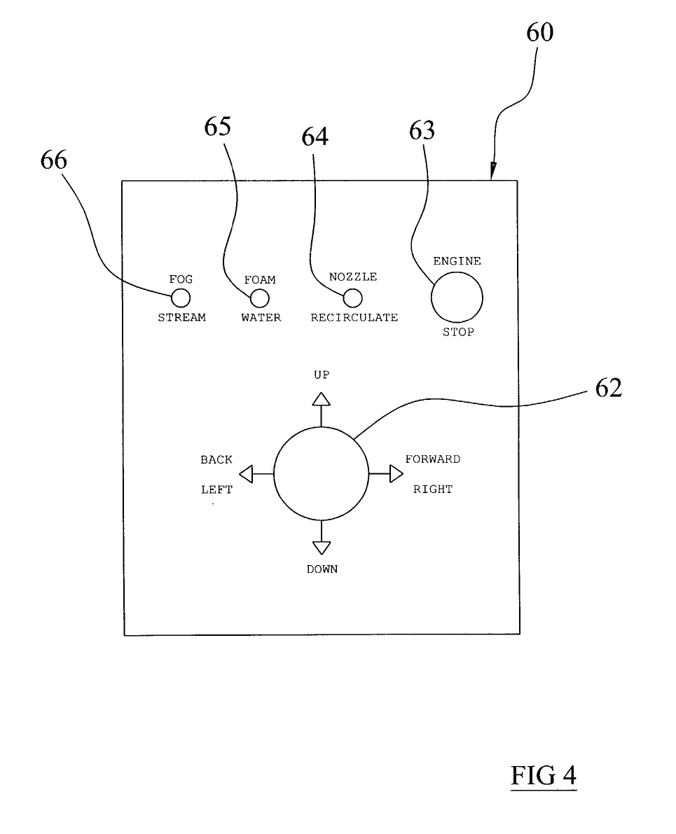

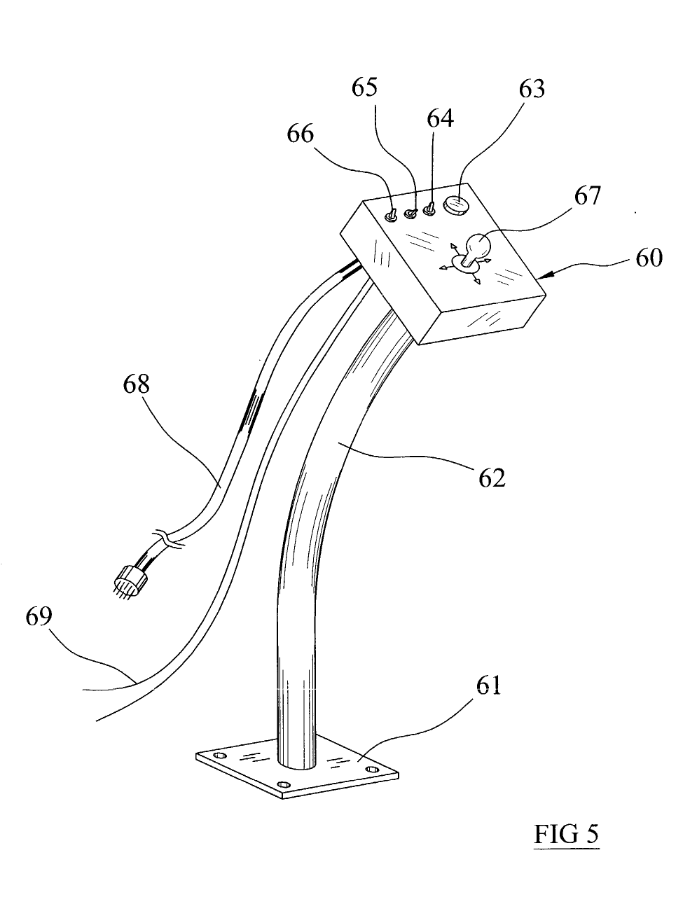

Turning now descriptively to the drawings, in which similar reference characters denote similar elements throughout the several views, FIGS. 1 through 5 illustrate a firefighting system 10, which comprises a water tank 30 and a foam concentrate tank 40 connected to a fluid distribution system 50. A motor 20 provides the required power to run the fluid distribution system 50. The fluid distribution system 50 draws either water or foam concentrate from the corresponding water tank 30 or foam concentrate tank 40 and sends the corresponding fluid to an adjustable nozzle 70. The control panel 60 is attached to a stand 62. The stand 62 is preferably attached to the floor of the cab of a standard commercially available pickup truck. Other than the control panel 60 and stand 62 all component parts of the firefighting system 10 fit into the bed of a commercially available pickup truck.

The water tank 30 is preferably constructed of materials capable of holding a sufficient volume of water to fight a wildland fire. The water tank 30 should be watertight, and as seen in FIG. 1, of a dimension that will fit in the bed of a standard commercially available pickup truck. The water tank 30 is designed to facilitate water being drawn from the water tank 30 by the fluid distribution system 50.

The foam concentrate tank 40 is preferably constructed of materials capable of holding a sufficient volume of foam concentrate to fight a wildland fire. As seen in FIG. 1, the foam concentrate tank 40 should be of a dimension that will fit in the bed of a standard commercially available pickup truck and watertight. The foam concentrate tank 40 is designed to facilitate foam concentrate being drawn from the foam concentrate tank 40.

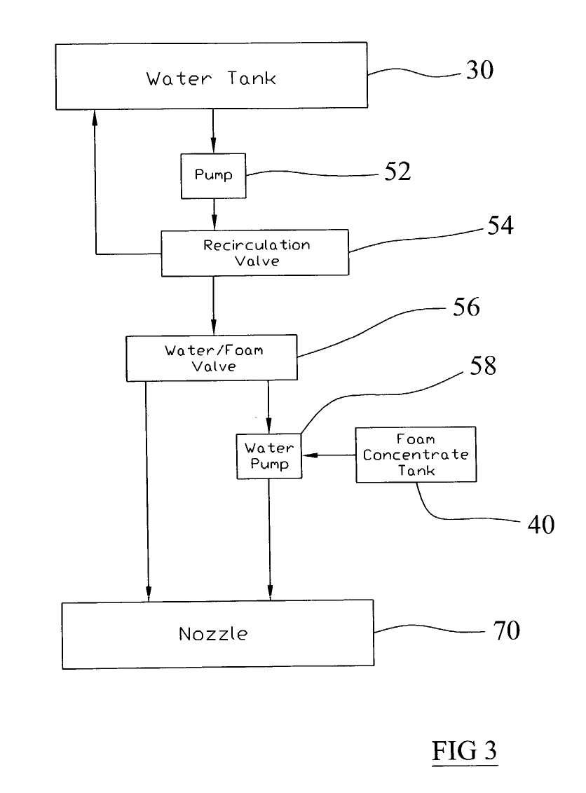

The fluid distribution system 50 is designed to draw water from the water supply and direct it to be expelled from the nozzle 70, or to direct the water to mix with the foam concentrate and for the resulting foam to be expelled from the nozzle 70. The fluid distribution system 50 may include a pump 52, a recirculation valve 54, a water/foam valve 56 and a water pump 58. As shown in the flowchart in FIG. 3, the water in the water tank 30 may be drawn out and forced through the system by the use of a pump 52. The pump 52 may force the water to a recirculation valve 54. The recirculation valve 54 can be set to either allow water to continue through the fluid distribution system 50 to the nozzle 70 or to be recirculated back to the water supply. This ability to recirculate water is designed to keep the pump 52 from overheating when the firefighting system 10 is not discharging fluid to fight a fire. The fluid distribution system 50 may use a water/foam valve 56 to direct the water either directly thorough the system to the nozzle 70 or to direct the water to drive the water pump 58. When the water is directed to the water pump 58 the water pump 58 draws foam concentrate from the foam concentrate tank 40 and combines it with water to create dischargeable foam.

An adjustable nozzle 70 is connected to the fluid distribution system. The nozzle 70 is preferably designed to adjust the stream of fluid leaving the nozzle 70 from a fine mist to a steady stream. The nozzle 70 may additionally have the capability to be aimed to change the direction and angle of the spray of fluid leaving the nozzle 70.

The fluid distribution system 50 is powered by a motor 20. As seen in FIG. 1, the motor 20 should be of a size large enough to run the system and easily fit into the bed of a standard commercially available pickup truck.

The control panel 60 is attached to a stand 62 which is attached to a base plate 61. The base plate 61 is designed for attachment to the floor of the cab in a standard commercially available pickup truck. The stand 62 is preferably made from material that allows the stand 62 to flex to increase the durability and functionality of the stand 62. The control panel 60 has a power cord 69 for connection to the pickup trucks electrical supply. The control panel 60 also includes a wiring harness 68 to distribute control inputs to the fluid distribution system and nozzle 70. The control panel 60 includes a joystick 67, a recirculation valve switch 64, a water/foam valve switch 65 and a fog/stream switch 66.

In use, the firefighting system 10 is placed in the bed of a standard commercially available pickup truck and secured. The base plate 62 is attached to the floor of the cab and the pickup trucks electrical power is connected to the control panel 60 through the power cord 69. The wiring harness 68 from the control panel 60 is then attached to the fluid distribution system 50, the motor 20 and the nozzle 70.

The firefighting system 10 is then placed in proximity to a wildland fire and the motor 20 is engaged. The user of the firefighting system 10 sits in the comfort of a preferably air-conditioned cab of the standard pickup truck. The recirculation valve switch 64 is engaged sending water through the system. The fog/stream switch is then set to the desired spray pattern and the signal is relayed through the wiring harness 68 to the nozzle 70 which incorporates the designated spray pattern. The joystick 67 may be manipulated by the operator. As the joystick 67 is moved the corresponding signal is sent to the nozzle 70 through the wiring harness 68 directing where the nozzle 70 is to be aimed. If the operator desires foam the operator sets the water/foam switch 65 of the control panel 60 to the desired position. The water/foam switch 65 sends a signal through the wiring harness 68 to the water/foam valve 56. The water/foam valve 56 then directs the water to the water pump 58. As water flows through water pump 58 it turns and draws foam concentrate from the foam concentrate tank 40. The foam concentrate mixes into the water flow and the resulting foam is sent out the nozzle 70. If the operator wants to stop the flow of fluids out the nozzle he sets the recirculation valve switch 64 on the control panel 60 to the appropriate position. The recirculation valve switch 64 sends a signal to the recirculation valve which causes the water to be directed to the water tank 30. When the operator no longer desires the system to be operational he engages the engine stop switch 63 which sends the appropriate signal to the motor 20 through the wiring harness 68 to stop the motor 20.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A firefighting system positionable within a bed of a motorized vehicle, comprising:
a fluid distribution system;
a first tank in fluid connection with said fluid distribution system capable of holding a volume of a first fluid;
a second tank in fluid connection with said fluid distribution system; capable of holding a volume of a second fluid;
a pump fluidly connected to said fluid distribution system;
a nozzle in fluid connection with said fluid distribution system; and
a control panel in communication with said pump and said fluid distribution system.

2. The firefighting system of claim 1, wherein said first tank has a volume capacity greater than a volume capacity of said second tank.

3. The firefighting system of claim 1, wherein said nozzle is adjustable to dispense fluid from a mist to a direct stream.

4. The firefighting system of claim 1, wherein said control panel controls said nozzle to adjust a spray pattern of said nozzle.

5. The firefighting system of claim 1, wherein said control panel has a joystick in communication with said nozzle for controlling said nozzle.

6. The firefighting system of claim 1, wherein said control panel has a kill switch to terminate operation of said pump.

7. The firefighting system of claim 1, including a generator connected to said pump.

8. The firefighting system of claim 1, wherein said fluid distribution system includes a valve which may direct a fluid to said nozzle or to said water pump.

9. The firefighting system of claim 8, wherein said control panel includes a recirculation switch in communication with said valve.

10. The firefighting system of claim 9, wherein said fluid distribution system includes a recirculation valve which is capable of directing a fluid through said fluid distribution system or returning a fluid to said first tank.

11. A firefighting system positionable within a bed of a motorized vehicle, comprising:
a fluid distribution system;
a first tank in fluid connection with said fluid distribution system capable of holding a volume of a first fluid;
a second tank in fluid connection with said fluid distribution system; capable of holding a volume of a second fluid;
wherein said first tank and said second tank are formed to fit within said bed of said motorized vehicle;
a pump fluidly connected to said fluid distribution system;
a nozzle in fluid connection with said fluid distribution system; and
a control panel in communication with said pump and said fluid distribution system.

12. The firefighting system of claim 11, wherein said first tank has a volume capacity greater than a volume capacity of said second tank.

13. The firefighting system of claim 11, wherein said nozzle is adjustable to dispense fluid from a mist to a direct stream.

14. The firefighting system of claim 11, wherein said control panel controls said nozzle to adjust a spray pattern of said nozzle.

15. The firefighting system of claim 11, wherein said control panel has a joystick in communication with said nozzle for controlling said nozzle.

16. The firefighting system of claim 11, wherein said control panel has a kill switch to terminate operation of said pump.

17. The firefighting system of claim 11, including a generator connected to said pump.

18. The firefighting system of claim 11, wherein said fluid distribution system includes a valve which may direct a fluid to said nozzle or to said water pump.

19. The firefighting system of claim 18, wherein said control panel includes a recirculation switch in communication with said valve.

20. The firefighting system of claim 19, wherein said fluid distribution system includes a recirculation valve which is capable of directing a fluid through said fluid distribution system or returning a fluid to said first tank.
